(19) United States
(12) Patent Application Publication
(10) Pub. No.: US 2025/0270717 A1
(43) Pub. Date: Aug. 28, 2025

(54) METHODS FOR PRODUCING PLATINUM NANOPARTICLES DECORATED TRANSITION METAL DICHALCOGENIDES AND USES THEREOF IN HYDROGEN EVOLUTION REACTIONS

(71) Applicant: CITY UNIVERSITY OF HONG KONG, Kowloon (HK)

(72) Inventors: Zhiyuan ZENG, Kowloon (HK); Liang MEI, Kowloon (HK)

(21) Appl. No.: 18/943,539

(22) Filed: Nov. 11, 2024

Related U.S. Application Data
(60) Provisional application No. 63/556,869, filed on Feb. 22, 2024.

(51) Int. Cl. C25B 11/075; C25B 1/04; C25B 11/067; H01M 10/54

(52) U.S. Cl. CPC C25B 11/075; C25B 1/04; C25B 11/067; H01M 10/54

(57) ABSTRACT

Disclosed herein is a method for producing a platinum (Pt) decorated single-layer transition metal dichalcogenide (TMD) composite. The method includes steps of, (a) mixing single-layer TMD nanosheets with a reducing agent, K₂PtCl₄, and water to form a mixture, wherein the reducing agent and the K₂PtCl₄ are present in a molar ratio of 3:2 in the mixture; and (b) irradiating the mixture of step (a) for about 0.1-2 hrs to allow the growth of Pt nanoparticles on the single-layer TMD nanosheets thereby forming the Pt decorated single-layer TMD composite. Also disclosed herein is a method of producing hydrogen from an aqueous solution. The method includes electrolyzing the aqueous solution in an electrochemical cell characterizing in having an electrode made from the present Pt decorated single-layer TMD composite.

### CROSS-REFERENCE TO RELATED APPLICATION

This application claims priority and the benefit of U.S. Provisional Patent Application No. 63/556,869, filed Feb. 22, 2024, the entirety of which is incorporated herein by reference.

### BACKGROUND OF THE INVENTION

### 1. Field of the Invention

The present invention relates to methods of producing electrodes comprising 1T/1T'-phase transition metal dichalcogenide (TMD) nanosheets, and their uses in hydrogen evolution reaction (HER).

### 2. Description of Related Art

Energy scarcity.

Due to energy scarcity, industry and researcher throughout the world are eager to develop an efficient and inexpensive electrocatalyst for producing clean energy (i.e., hydrogen) from the most abundant source on earth (i.e., water) via water splitting, or hydrogen evolution reaction (HER). Two-dimensional (2D) materials, particularly, 2D-transition metal dichalcogenides (2D-TMDs), have become an alternative electrocatalyst due to their high aspect ratios and ultrathin structures. A number of ways have been proposed to enhance the electrocatalytic activities of 2D-TMDs, including doping, formation of composites, introducing defects in the lattice, and etc. To date, forming composite of two or more materials has been regarded as the best way to enhance the electrocatalytic activities of 2D-TMDs. Not only does the formation of composite may address the limitation of individual material, but also can maximize the function of each material. Most importantly, the combination of materials may bring new function to the newly formed composite. However, current methods for forming TMD composites are either too stringent (e.g., require operation at high temperature) or un-environmentally friendly. Accordingly, there exists in the related art a need of an improved method for producing TMD composite in an easy-to-use and environmentally friendly manner, and the TMD composite possesses high electrocatalytic activity, thus can serve as a catalyst for reducing hydrogen ions into hydrogen via HER.

### SUMMARY

Embodiments of the present disclosure relate to methods of producing Pt nanoparticles decorated single-layer metal dichalcogenide (TMD) composites. The thus produced composites may be used in an electrochemical cell to produce hydrogen from an aqueous solution via hydrogen evolution reaction (HER).

The first objective of the present disclosure therefore aims to provide a method of producing Pt nanoparticles decorated single-layer TMD composites. The method comprises:
(a) mixing single-layer TMD nanosheets with a reducing agent, K₂PtCl₄, and water to form a mixture, wherein the reducing agent and the K₂PtCl₄ are present in a molar ratio of 3:2 in the mixture; and
(b) irradiating the mixture of step (a) for about 0.1-2 hrs to let Pt nanoparticles grow on the single-layer TMD nanosheets thereby forming the Pt nanoparticles decorated single-layer TMD composite;
   wherein,
each Pt nanoparticle grown on the single-layer TMD nanosheets is about 0.8 nm to 1.8 nm in diameter.

According to embodiments of the present disclosure, the single-layer TMD nanosheets are produced by,
(i) discharging a bulk TMD in a lithium battery to produce a lithiated bulk TMD;
(ii) sonicating the lithiated bulk TMD in water to exfoliate the lithiated bulk TMD into the single-layer TMD nanosheets;
(iii) collecting the product of step (ii) by centrifugation; and
(iv) re-dispersing the product of step (iii) in water to produce the single-layer TMD nanosheets;
   wherein,
the lithium battery comprises:
an anode made of a lithium foil;
a cathode made of a copper foil having the bulk TMD coated thereon; and an electrolyte consisting of LiPF₆, ethyl carbonate (EC), and dimethyl carbonate (DMC).

According to embodiments of the present disclosure, in step (i), a constant current of 0.025 mA and a cutoff voltage of 0.9V are applied to the lithium battery to discharge the bulk TMD.

According to embodiments of the present disclosure, in step (iii), the product of step (ii) was collected by 2-step centrifugation via respectively centrifuging at speeds under 2,000 rpm and 8,000 rpm for 15 minutes.

According to embodiments of the present disclosure, the single-layer TMD nanosheets are single-layer TaS₂ nanosheets, single-layer TiS₂ nanosheets, or single-layer MoS₂ nanosheets. In some embodiments, the single-layer TMD nanosheets are single-layer TaS₂ nanosheets. In other embodiments, the single-layer TMD nanosheets are single-layer TiS₂ nanosheets.

Examples of the reducing agent suitable for use in the present disclosure include, but are not limited to, trisodium citrate, sodium borohydride (NaBH₄) and the like. Preferably, the reducing agent is trisodium citrate,

Accordingly, the second objective of the present disclosure aims at providing an electrochemical cell for HER. The electrochemical cell comprises in its structure,
a working electrode produced by coating a glass substrate with an ink solution, and air-drying the ink solution coated glass substrate, wherein the ink solution is produced by,
   (i) mixing the present Pt decorated single-layer TMD composite and a solution to give a mixture, in which the solution consists of water, ethanol and 5% sulfonated polytetrafluoroethylene copolymer at a volume ratio of 4:1: 0.1; and
   (ii) sonicating the mixture to produce the ink solution;
a reference electrode;
a counter-electrode; and
an electrolyte consisting of 0.5 M sulfuric acid.

The third aspect of the present disclosure thus is directed to a method for producing hydrogen from an aqueous solution. The method comprises electrolyzing the aqueous solution in the present electrochemical cell.

According to embodiments of the present disclosure, the aqueous solution is water.

Other and further embodiments of the present disclosure are described in more detail below.

### BRIEF DESCRIPTION OF THE DRAWINGS

The disclosure will become more fully understood from the detailed description and the drawings given herein below for illustration only, and thus does not limit the disclosure, wherein:

FIG. 1 is a flowchart depicting a method 100 for producing single-layer TMD nanosheets in accordance with one embodiment of the present disclosure;

FIG. 2 is a flowchart depicting a method 200 for producing Pt decorated single-layer TMD composites in accordance with one preferred embodiment of the present disclosure;

FIG. 3 is a schematic drawing depicting a cell constructed for evaluating HER performance of the Pt-TaS₂ or Pt-TiS₂ electrodes in accordance with one embodiment of the present disclosure; and

FIG. 4 is a bar graph depicting the overpotentials at 10 mA/cm² of Pt-TaS₂-1h, Pt-TiS₂-1h, and Pt/C before and after 1,000 cycles test in accordance with one embodiment of the present disclosure.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

The term “electrocatalyst” as used herein refers to a catalyst that takes part in an electrochemical reaction in the form of a surface of an electrode or the electrode per se. Electrocatalyst may facilitate the transfer of electrons between an electrode and a reaction agent, and/or the intermediate reactions of half-reactions of the cell. Like other catalysts, the electrocatalyst may lower the activation energy level without changing the chemical equilibrium thereof.

The term “hydrogen evolution reaction (HER)” as used herein refers to the half reaction of electrochemical water splitting, in which hydrogen ions are reduced to hydrogen (i.e., 2H⁺+2e⁻→H₂), which is a key chemical agent and fuel. In general, the reduction of hydrogen ions into hydrogen requires the aid of a catalyst (e.g., Pt nanoparticles decorated TMD composites of the present disclosure).

### 1. Methods of Producing Pt Nanoparticles Decorated Transition Metal Dichalcogenide (TMD) Composites

The first objective of the present disclosure is directed to a method of producing Pt nanoparticles (NPs) decorated single-layer TMD composites. The Pt NPs decorated single-layer TMD composites are catalysts suitable for constructing electrodes of an electrochemical cell to generate hydrogen from an aqueous solution via hydrogen evolution reaction (HER).

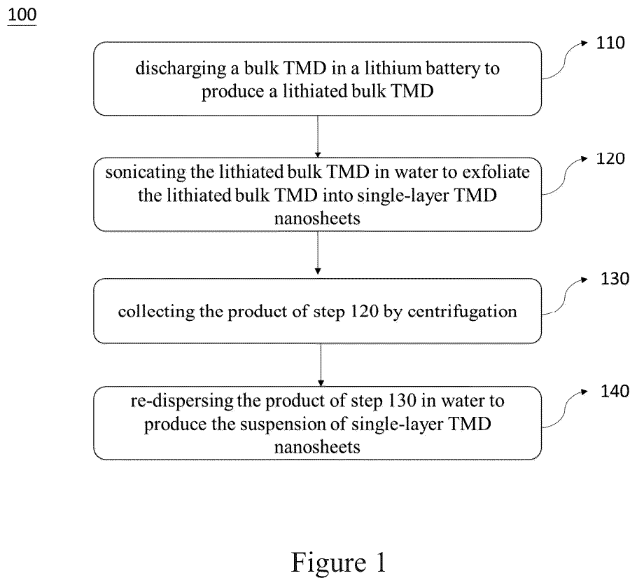

To produce the desired catalysts, single-layer TMD nanosheets are first produced by electrochemical lithium intercalation followed by exfoliation in water, detail steps are described in the flowchart in FIG. 1. To this purpose, a lithium battery for performing the method 100 described in the flowchart is constructed. Specifically, a cathode (i.e., bulk TMD (TaS₂ or TiS₂) coated copper foil) is assembled with an anode (i.e., a lithium foil), and an electrolyte (i.e., a mixture of LiPF₆, ethyl carbonate (EC), and dimethyl carbonate (DMC)) into the lithium battery, and a potential difference is applied to the battery to intercalate lithium ions into the cathode (FIG. 1, step 110). According to embodiments of the present disclosure, the lithium battery is discharged at a constant current of 0.025 mA and a cut off voltage of 0.9 V thereby producing a lithiated bulk TMD. The lithiated bulk TMD is then subjected to sonification in water so as to exfoliate the lithiated bulk TMD into single-layer TMD nanosheets (FIG. 1, step 120). The thus produced single-layer TMD nanosheets are subsequently collected via centrifugation (FIG. 1, step 130). According to preferred embodiments of the present disclosure, the single-layer TMD nanosheets are collected via 2-step centrifugation, in which the product of step 120 is first centrifuged at a speed no more than 2,000 rpm for 15 minutes, and subsequently at a speed of about 8,000 rpm for another 15 minutes. The collected TMD nanosheets are then re-dispersed in water to give the desired suspension of single-layer nanosheets (FIG. 1, step 140).

According to embodiments of the present disclosure, the exfoliated single-layer TMD nanosheets disperse very well in water, and this dispersion may be attributed to the negative charges on their surfaces. Further, each of the exfoliated single-layer TMD nanosheet has smooth surface and a thickness of less than 1 nm. Examples of the single-layer TMD nanosheets suitable for use in the present disclosure include, but are not limited to, single-layer molybdenum disulfide (MoS₂) nanosheets, single-layer tantalum disulfide (TaS₂) nanosheets, single-layer titanium disulfide (TiS₂) nanosheets, and etc. According to some embodiments of the present disclosure, the single-layer TMD nanosheets are the suspension of single-layer TaS₂ nanosheets. According to other embodiments of the present disclosure, the single-layer TMD nanosheets are the suspension of single-layer TiS₂ nanosheets.

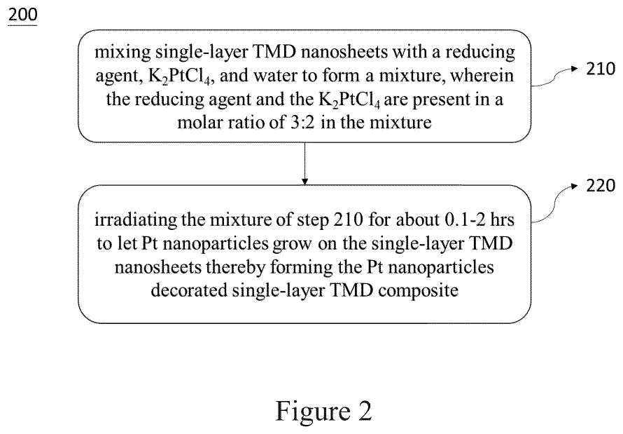

The single-layer TMD nanosheets (e.g., single-layer TaS₂ or TiS₂ nanosheets) thus produced may then be used to fabricate the desired catalyst, detail steps are described in the flowchart in FIG. 2. To this purpose, single-layer TMD nanosheets are mixed with a reducing agent, K₂PtCl₄, and water thereby forming a mixture (FIG. 2, step 210); the mixture is then irradiated for about 0.1-2 hrs to allow the growth of Pt nanoparticles on the single-layer TMD nanosheets thereby forming the Pt decorated single-layer TMD composite (FIG. 2, step 220).

According to embodiments of the present disclosure, in step 210, the reducing agent and the K₂PtCl₄ are present in a molar ratio of 3:2 in the mixture. Examples of reducing agent suitable for use in the present disclosure include, but are not limited to, trisodium citrate, sodium borohydride and the like. According to preferred embodiments, single-layer TMD nanosheets are mixed with K₂PtCl₄and trisodium citrate yielding a mixture containing Pt-based compound stabilized by trisodium citrate.

In step 220, the mixture is then exposed to irradiation, which leads to the reduction of K₂PtCl₄ in the presence of trisodium citrate, facilitating the formation of ultrasmall Pt nanoparticles on the single-layer TMD nanosheets. According to embodiments of the present disclosure, the irradiation time or the reduction time may vary from about 0.1 to 2 hrs, such as 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0 hrs. In some examples, the reduction time is about 0.5 hr. In other examples, the reduction time is about 1.0 hr. According to some embodiments of the present disclosure, as the irradiation time (or reduction time) increases from 0.5 hr to 1 hr, the size of the Pt particle deposited on single-layer TaS₂ nanosheet also increases from 0.82 nm to 1.28 nm; while the size of the Pt particle deposited on single-layer TiS₂nanosheet also increases from 0.88 nm to 1.63 nm. Furthermore, the step 220 of the present method is preferably carried out in ice-bath, so as to prevent the reactants from being overheat.

The thus produced Pt NPs decorated single-layer TMD composites may be collected via centrifugation. According to embodiments of the present disclosure, each Pt nanoparticle grown on the single-layer TMD nanosheets is about 0.8 nm to 1.8 nm in diameter, such as 0.8, 0.9, 1.0, 1.2, 1.3, 1.5, 1.6, 1.7 or 1.8 nm in diameter.

### 2. HER Performance of the Present Pt Decorated Single-Layer TMD Composite

The afore-mentioned Pt decorated single-layer TMD composite possesses higher electrochemical activity (i.e., Tafel slope) and may be used as electrocatalysts for generating hydrogen via HER. Accordingly, the second objective of the present disclosure is to provide an electrochemical cell for generating hydrogen from an aqueous solution. The electrochemical cell is characterized in having a working electrode (or a negative electrode) comprising Pt NPs decorated single-layer TMD composite.

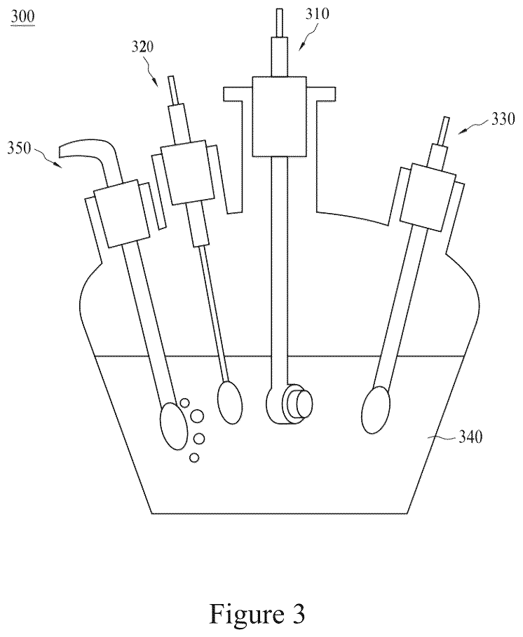

Reference is made to FIG. 3, which is a schematic drawing of an electrochemical cell 300 of the present disclosure. The cell 300 comprises in its structure, a working electrode 310, a reference electrode 320, a counter electrode 330, and an electrolyte 340, which is 0.5 M sulfuric acid.

According to embodiments of the present disclosure, the working electrode 310 is produced by coating a glass substrate with an ink solution; and air-drying the ink solution coated glass substrate. According to embodiments of the present disclosure, the ink solution is produced by, (i) mixing the present Pt decorated single-layer TMD composite and a solution to give a mixture, in which the solution consists of water, ethanol and 5% sulfonated polytetrafluoroethylene copolymer at a volume ratio of 4:1: 0.1; and (ii) sonicating the mixture to produce the ink solution. The working electrode 310 may then be assembled with suitable reference electrode 320, counter electrode 330 and electrolyte 340 into the desired electrochemical cell 300. Any ordinary skilled person in the related art can choose suitable reference electrode 320, counter electrode 330 and electrolyte 340 for the assembly of the cell 300 without undue experimentation.

According to embodiments of the present disclosure, the electrocatalytic activity of the present Pt decorated single-layer TMD composite is evaluated via measuring the changes of overpotential with current density in the electrochemical cell 300. Accordingly, a Tafel plot is produced and Tafel slope (mV/dec) is used as an indicator for the electrocatalytic activity. Note that Tafel slope is a measure of how the current density changes with overpotential, specifically, the number of mV required for increasing current density by 10 folds. Thus, the smaller the Tafel slope, the higher the electrocatalytic activity, as less overpotential is needed to reach higher current density. In some embodiments, after depositing the Pt NPs, the Tafel slope decreases from 128 mV/dec for TaS₂ to 62 mV/dec for Pt-TaS₂-0.5h and ₅₀ mV/dec for Pt-TaS₂-1h. In other embodiments, after deposition of Pt NPs, the Tafel slope decreases from 128 mV/dec for TiS₂ to 82 mV/dec for Pt-TiS₂-0.5h and 55 mV/dec for Pt-TiS₂-1h.

The third objective of the present disclosure thus is directed to a method for generating hydrogen. The method comprises electrolyzing an aqueous solution in the electrochemical cell described above.

According to embodiments of the present disclosure, the aqueous solution is water.

The present invention will now be described more specifically with reference to the following embodiments, which are provided for the purpose of demonstration rather than limitation. While they are typically of those that might be used, other procedures, methodologies, or techniques known to those skilled in the art may alternatively be used.

### EXAMPLES

### Material and Methods

Preparation of the Single-layer TaS₂ and TiS₂ Nanosheets

Single-layer TaS₂ and TiS₂ nanosheets were synthesized using a well-established procedure involving electrochemical lithium intercalation followed by exfoliation in water. In the lithium intercalation step, a lithium-ion battery configuration was utilized, with lithium foil serving as the anode and bulk TMDs (TaS₂ or TiS₂) coated on copper foil acting as the cathode. The electrolyte used in this process consisted of a 1 M LiPF₆ solution dissolved in a mixture of ethyl carbonate (EC) and dimethyl carbonate (DMC) (in a 1:1 volume ratio). To separate the anode and cathode, a polypropylene (PP) film was utilized. The battery was operated using galvanostatic discharge, with a constant current of 0.025 mA and a cutoff voltage of 0.9V, facilitating the lithiation process. Subsequently, the LiₓTaS₂(LiₓTiS₂) sample obtained from the lithiation process was carefully extracted and subjected to sonication in DI water to exfoliate the bulk sample into single-layer nanosheets. To ensure purity, the resulted nanosheets underwent centrifugation and were thoroughly washed with DI water to remove any residual lithium ions and any remaining electrolytes, as well as other potential contaminants.

Synthesis of the Pt-TaS₂ or Pt-TiS₂ Composites

A 1 mL sample of prepared TaS₂ (or TiS₂) nanosheets was combined with 0.3 mM trisodium citrate, 0.2 mM K₂PtCl₄, and DI water to create an 18 mL solution. The reduction process was initiated by the catalytic reaction of photons generated from a 150 W halogen lamp. To prevent excessive heating of the growth species, an ice bath was employed during the irradiation process. The photo-irradiation was lasted for 0.5 hours or 1 hour, allowing for an examination of the impact of the reduction time on the morphology of the composites and their performance for HER application. During the irradiation, as Pt NPs were grown on TaS₂, the solution's color transitioned from purplish gray to a light yellowish-gray shade. Conversely, when Pt NPs were grown on TiS₂, the solution's color changed from gray to pale yellowish-gray. Following the irradiation, the resulted composite materials, Pt-TaS₂ and Pt-TiS₂, were collected via centrifugation and subsequently washed with DI water in preparation for further characterization and electrochemical testing.

### Material Characterization

A drop of a dilute solution containing TMDs nanosheets or Pt-TMDs composites were coated onto a holey carbon-coated copper grid, Si/SiO₂, APTES-modified Si/SiO₂, Si/SiO₂, Si/SiO₂ and glass. The coated samples were then left to air dry naturally before undergoing characterizations by transmission electron microscopy (TEM, JEM 2100F), scanning electron microscopy (SEM, JSM-7600), atomic force microscopy (AFM, Dimension 3100, Vecco, CA), X-ray photoelectron spectroscopy (XPS, Thermo Fisher ESCALAB XI), Raman spectroscopy (WITec alpha 300 confocal Raman microscope), respectively. Additionally, the purity of bulk TaS₂ and TiS₂ was confirmed using X-ray diffraction (XRD, D2 PHASER XE-T). The atomic arrangement of exfoliated TaS₂ and TiS₂ was checked by high-angle annular dark-field scanning transmission electron microscopy (HAADF-STEM, double Cs-corrected JEOL-ARM300). The surface charge of TaS₂ and TiS₂ nanosheets was measured by Zeta potential (Malvern Zetasizer Nano series).

### Electrocatalytic Measurements

Pt-TaS₂, Pt-TiS₂, and Pt/C were evaluated for their HER performance in a 0.5 M H₂SO₄ solution. The catalyst ink was prepared as follows: Each sample was mixed with a solution containing DI water, ethanol, and 5% NAFION™ (or sulfonated polytetrafluoroethylene copolymer) in a volume ratio of 4:1:0.1. The mixture was then subjected to ultrasonication to ensure uniform dispersion of the catalyst. Subsequently, the well-dispersed ink was coated onto a glass carbon electrode and allowed to air dry, creating the working electrode. For the electrochemical testing, linear sweep voltammetry (LSV) was conducted at a scan rate of 0.002 V/s, and cyclic voltammetry (CV) was performed at a scan rate of 0.1 V/s. Electrochemical impedance spectroscopy (EIS) was conducted over a frequency range spanning from 0.1 Hz to 10⁵ Hz. Throughout the testing, nitrogen gas was used to purge the electrolyte to prevent the oxidation of the samples.

### Example 1: Fabrication and Characterization of Pt-decorated TaS₂/TiS₂ Composites

### 1.1 Pt-decorated TaS₂/TiS₂ Composites

In this example, single-layer TaS₂ or TiS₂ were produced by procedures involving electrochemical lithium intercalation followed by exfoliation in water in accordance with procedures described in the “Materials and methods” section. Briefly, a lithium-ion battery was constructed, and the battery was operated using galvanostatic discharge, with a constant current of 0.025 mA and a cutoff voltage of 0.9V, facilitating the lithiation process. Then, the LiₓTaS₂/Li₂TiS₂ sample obtained from the lithiation process was carefully extracted and sonicated in distilled water to exfoliate the bulk sample into single-layer nanosheets. To ensure purity, the resulted nanosheets underwent centrifugation and were thoroughly washed with distilled (DI) water to remove any residual lithium ions and any remaining electrolytes, as well as other potential contaminants. The layered structure of the bulk TaS₂ or TiS₂ were clearly observed in their Scanning electron microscopy (SEM) images, and their high-purity phase was confirmed through XRD spectra analysis (data not shown).

The thus prepared single-layer TaS₂/TiS₂ nanosheets were then mixed with K₂PtCl₄and trisodium citrate, yielding a precursor precipitate containing a Pt-based compound stabilized by trisodium citrate. Subsequently, this mixture was exposed to irradiation from a 150 W halogen lamp. This irradiation process led to the reduction of K₂PtCl₄in the presence of trisodium citrate, facilitating the formation of ultrasmall Pt NPs that were then deposited onto the single-layer TaS₂ or TiS₂ nanosheets. After altering the reduction time (0.5 h or 1 h), the Pt-TaS₂ or Pt-TiS₂ composites were collected and subsequently refined through a purification process.

### 1.2 Structure and Morphological Characterization

### 1.2.1 TaS₂/TiS₂ Nanosheets

The exfoliated TaS₂ or TiS₂ nanosheets dispersed very well in deionized (DI) water. This dispersion may be attributed to the negative charge on their surfaces, as indicated by zeta potential measurements (TaS₂: −63.1 mV, TiS₂: −56.8 mV). This negative charge arises from electron transfer to the metal atom (Ta or Ti) during lithium intercalation. AFM measurements confirm that the thickness of both TaS₂ and TiS₂ nanosheets are less than 1 nm, validating the successful synthesis of monolayer nanosheets. TEM images further revealed typical TaS₂ or TiS₂ nanosheets possessed smooth surfaces. The selected area electron diffraction (SAED) patterns displayed six brighter spots on the outer side corresponding to (110) planes, while the weaker ones on the inner side were attributed to the (100) planes. The measured lattice spacing of TaS₂ or TiS₂ was around 1.7 Å, which is assigned to their (110) plane.

To facilitate the deposition of Pt NPs onto the single-layer TMDs nanosheets, the impact of centrifugal speed on the lateral size of the purified TaS₂ or TiS₂ nanosheets was further investigated. It was found that a two-step centrifugation process at speeds under 2,000 rpm and then 8,000 rpm for 15 minutes each represented the optimal conditions for producing large-area single-layer TMDs nanosheets with high yield, which are advantageous for the subsequent growth of Pt NPs.

### 1.2.2 Pt-decorated TaS₂/TiS₂ Composites

TEM images of Pt-TaS₂ and Pt-TiS₂ composites obtained with different irradiation times (0.5h, 1h, denoted as Pt-TaS₂-0.5h, Pt-TaS₂-1h, Pt-TiS₂-0.5h, Pt-TiS₂-1h, respectively). The density of Pt NPs on TaS₂ and TiS₂ nanosheets increased with the irradiation time. The SAED pattern of both Pt-TaS₂-0.5h and Pt-TaS₂-1h composites shows the typical hexagonal pattern for TaS₂, with the outer six spots attributed to (110) planes, while the inner six spots were assigned to (100) planes. For the Pt NPs densely loaded on TiS₂ nanosheets, in addition to the (110) and (100) planes observed from the SAED pattern, a continuous ring that was assigned to the (111) planes of Pt NPs was also noted. This is further confirmed by the high-resolution TEM images of Pt-TaS₂-1h and Pt-TiS₂-1h, with a measured d-spacing of 2.2 Å, assignable to the Pt (111) planes (data not shown).

The average Pt NPs size, determined from an analysis of 100 NPs, was found to be 1.28 nm and 1.63 nm for Pt-TaS₂-1h and Pt-TiS₂-1h, respectively. These Pt NPs are uniformly distributed across the entire TaS₂ and TiS₂ nanosheets. In general, the size of Pt nanoparticles could be adjusted by regulating the duration of photochemical reduction. With an increase in the photochemical reduction time from 0.5 h to 1h, the average size of Pt nanoparticles increased from 0.82 nm to 1.28 nm for TaS₂ and from 0.88 nm to 1.63 nm for TiS₂ (data not shown). Note that the size of Pt NPs fabricated in this work were much smaller than the method using NaBH₄ as the reductant (2-6 nm in size).

### Example 2 Electrochemical Properties of Pt-decorated TaS₂/TiS₂ Composites

The Pt decorated TaS₂/TiS₂ composites of Example 1 were fabricated into electrodes in accordance with procedures described in the “Materials and methods” section.

The electrocatalytic performance of Pt-TaS₂ or Pt-TiS₂ electrodes with varying growth times was evaluated in the electrochemical cell (FIG. 3) using linear sweep voltammetry (LSV). In comparison to pristine TaS₂ and TiS₂ nanosheets, all Pt-decorated composites exhibited enhanced activity, as evidenced by the decreased overpotentials at a current density of 10 mA/cm² in the polarization curves. This enhancement could be attributed to the synergistic coupling effect between TMDs nanosheets and Pt NPs. For instance, the metallic properties of TaS₂ and TiS₂ with an ultrathin structure facilitate electron transfer, while the Pt NPs possess the optimal Gibbs free energy for H* adsorption (neither too strong nor too weak). From the Tafel plots, it was evident that after depositing the Pt NPs, the Tafel slope decreased from 128 mV/dec for TaS₂ to 62 mV/dec for Pt-TaS₂-0.5 h and 50 mV/dec for Pt-TaS₂-1h. A similar enhancement in catalytic activity was also observed for Pt-TiS₂ composites, with the Tafel slope lowering from 128 mV/dec for TiS₂ to 82 mV/dec for Pt-TiS₂-0.5h and 55 mV/dec for Pt-TiS₂-1h. Electrochemical impedance spectroscopy (EIS) was also employed to assess the charge transfer resistance of Pt-TaS₂, Pt-TiS₂, as well as the pristine TaS₂ and TiS₂ electrodes. Further, the radius of the semicircles in the high-frequency region of Nyquist plots reflects the charge-transfer resistance (R_{ct}), which signifies the resistance of charge transfer at the interface between the electrolyte and the electrode. Pt-TaS₂-1h exhibited the smallest charge transfer resistance compared to Pt-TaS₂-0.5h and pristine TaS₂ (data not shown). This further confirmed the efficient charge transfer kinetics of Pt-TaS₂-1h during the HER. Similarly, Pt-TiS₂-1h displayed the lowest charge transfer resistance compared to Pt-TiS₂-0.5h and pristine TiS₂.

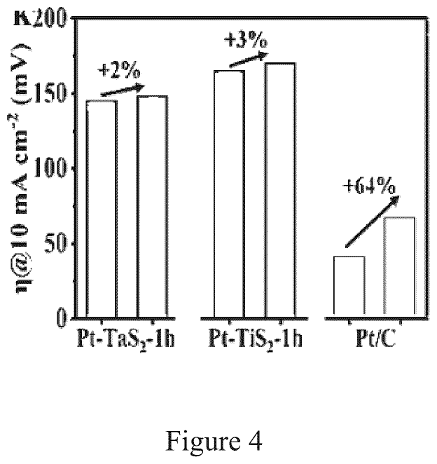

Cyclic stability is a crucial consideration for practical applications. Therefore, Pt-TaS₂ and Pt-TiS₂ composites, as well as commercial Pt/C, were subjected to 1,000 cycles to assess their stability. It was found that the polarization curves of both Pt-TaS₂-1h and Pt-TiS₂-1h for the HER after 1,000 cycles closely resembled the initial one, with negligible loss of cathodic current, indicating excellent stability. However, for commercial Pt/C, the cathodic current significantly decreased after 1,000 cycles. Regarding the overpotential at a current density of 10 mA/cm², after 1,000 cycles, Pt-TaS₂-1h increased by 2%, Pt-TiS₂-1h increased by 3%, and Pt/C increased by a substantial 64% (FIG. 4).

Taken together, these results imply that while the catalytic activity of Pt-TaS₂-1h and Pt-TiS₂-1h was slightly lower than that of commercial Pt/C, but their cycling stability was significantly better. The poor stability observed in commercial Pt/C could be attributed to the corrosion or dissolution of Pt nanoparticles into the electrolyte during the process of the HER over time. This dissolution might decrease the active surface area, consequently impairing the catalytic efficiency of Pt/C. Comparing the HER performance of Pt-TaS₂-1h and Pt-TiS₂-1h with previously reported TaS₂ and TiS₂-based catalysts, it was evident that the Pt-TaS₂-1h and Pt-TiS₂-1h composites developed in this study exhibited much better activity than most of the other catalysts, considering factors like the Tafel slope and overpotential at a current density of 10 mA/cm². Consequently, Pt-TaS₂/TiS₂ hold promise as alternatives to commercial Pt/C catalysts for HER applications. In this study, TMDs (TaS₂, TiS₂) were utilized as 2D templates to stabilize ultrasmall Pt NPs (1.2-1.6 nm). It was reported that without using the TMDs template, the synthesized Pt NPs exhibited larger sizes ranging from 7 to 18 nm. The presence of these stabilized ultrasmall Pt NPs on the TMD surface significantly contributed to their advanced HER activity and stability.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of the present disclosure.

What is claimed is:

1. A method of producing a platinum (Pt) decorated single-layer transition metal dichalcogenide (TMD) composite comprising:
(a) mixing single-layer TMD nanosheets with a reducing agent, K₂PtCl₄, and water to form a mixture, wherein the reducing agent and the K₂PtCl₄are present in a molar ratio of 3:2 in the mixture; and
(b) irradiating the mixture of step (a) for about 0.1-2 hrs to let Pt nanoparticles grow on the single-layer TMD nanosheets thereby forming the Pt decorated single-layer TMD composite;
wherein,
each Pt nanoparticle grown on the single-layer TMD nanosheets is about 0.8 nm to 1.8 nm in diameter.

2. The method of claim 1, wherein the single-layer TMD nanosheets are produced by,
(i) discharging a bulk TMD in a lithium battery to produce a lithiated bulk TMD;
(ii) sonicating the lithiated bulk TMD in water to exfoliate the lithiated bulk TMD into the single-layer TMD nanosheets;
(iii) collecting the product of step (ii) by centrifugation; and
(iv) re-dispersing the product of step (iii) in water to produce the single-layer TMD nanosheets;
wherein,
the lithium battery comprises:
an anode made of a lithium foil;
a cathode made of a copper foil having the bulk TMD coated thereon; and
an electrolyte consisting of LiPF6, ethyl carbonate (EC), and dimethyl carbonate (DMC).

3. The method of claim 2, wherein in step (i), a constant current of 0.025 mA and a cutoff voltage of 0.9V are applied to the lithium battery to discharge the bulk TMD.

4. The method of claim 2, wherein in step (iii), the product of step (ii) was collected by 2-step centrifugation at speeds under 2,000 rpm and 8,000 rpm, respectively, each for 15 minutes.

5. The method of claim 1, wherein the single-layer TMD nanosheets are single-layer TaS₂ nanosheets, single-layer TiS₂ nanosheets, or single-layer MoS₂ nanosheets.

6. The method of claim 1, wherein the reducing agent is trisodium citrate or sodium borohydride (NaBH₄).

7. The method of claim 6, wherein the reducing agent is trisodium citrate.

8. A cell comprising:
a working electrode produced by coating a glass substrate with an ink solution, and air-drying the ink solution coated glass substrate, wherein the ink solution is produced by,
(i) mixing the Pt decorated single-layer TMD composite produced by the method of claim 1 and a solution to give a mixture, in which the solution consists of water, ethanol and 5% sulfonated polytetrafluoroethylene copolymer at a volume ratio of 4:1:0.1; and
(ii) sonicating the mixture to produce the ink solution;
a reference electrode;
a counter-electrode; and
an electrolyte consisting of 0.5 M sulfuric acid.

9. A method for producing hydrogen from an aqueous solution comprising electrolyzing the aqueous solution in the cell of claim 8.

10. The method of claim 9, wherein the aqueous solution is water.
